(19) United States
(12) Patent Application Publication
(10) Pub. No.: US 2004/0124386 A1
(43) Pub. Date: Jul. 1, 2004

(54) Lateral reducing valve

(76) Inventor: Wayne Carey, Wayne, NJ (US)

Correspondence Address: Wolff & Samson PC, One Boland Drive, West Orange, NJ, 07052, US

(21) Appl. No.: 10/426,890

(22) Filed: Apr. 30, 2003

Related U.S. Application Data
(60) Provisional application No. 60/436,571, filed on Dec. 26, 2002.

(51) Int. Cl. F16K 51/00

(52) U.S. Cl. 251/148

(57) ABSTRACT

An adaptor is provided for connecting a valve to a pipe fitting, wherein the valve and the fitting have different diameters. The adaptor has a first end sized for insertion into the pipe fitting and retention thereby, and a second threaded end for threadably receiving an end of the valve. The adaptor allows a portion of the valve to be recessed within the fitting, and provides a compact, strong connection between the valve and the fitting.

### RELATED APPLICATIONS

This application claims the priority of Provisional Patent Application Serial No. 60/436,571, filed Dec. 26, 2002, the entire disclosure of which is expressly incorporated herein by reference.

### BACKGROUND OF THE INVENTION

1. Field of the Invention

The present invention relates to an adapter for connecting a fluid control valve, such as a ball valve, to a pipe fitting. The adapter is configured to recess the valve into the pipe fitting, or position the valve close to the pipe fitting, to reduce the lateral distance of the valve with respect to the pipe fitting.

2. Related Art

Ball valves are well known in the art to control the flow of fluid through conduits such as pipes and the like. Typical ball valves include a male threaded outlet and inlet on which are seated union ends. The union ends are secured to the inlet and outlet of the ball valve body by union nuts having female threads which threadably engage the male threads of the inlet and outlet. The union nuts catch a shoulder of the union ends to secure the union ends on the inlet and outlet. If connection is desired to a pipe or other conduit of the same diameter, the pipe is inserted through the union nut and into the union end where it is bonded so that it is seated end to end with the end of the inlet or outlet of the ball valve body. The union nut is tightened to secure the union end and the pipe in the ball valve body.

If connection is desired with a conduit of a different diameter, such as a three-way pipe “tee” or other pipe fitting, it is standard practice to attach the conduit to the ball valve using a reducer and a section of pipe. For example, if a 3-inch pipe fitting is to be connected to a 1-inch ball valve, a “3×1” reducer would be used. A 1-inch pipe is inserted and bonded into the union end and tightened to the ball valve inlet or outlet by the union nut. The other end of the pipe is inserted into the “3×1” reducer, which is inserted into the pipe fitting and attached thereto. A disadvantage of this configuration is that it is not well suited for use in tight spaces such as within walls, corners, and the like. In addition, the pipe is susceptible to weakening by physical stresses such as bending by pipe hangers, expansion and contraction due to temperature changes, and imperfect pipefitting; thus, this configuration may not be structurally reliable. In areas where the valve might be hit or bumped, an unnecessarily large moment arm is created about the pipe fitting due to the piping and reducer between the pipe fitting and the valve, thereby making the assembly vulnerable to breaking.

Accordingly, what would be desirable, but has not heretofore been provided, is a device for connecting a ball valve to a conduit or other connector having a different diameter than the ball valve, which connection is compact, sturdy, and can withstand physical pressures under routine use.

### SUMMARY OF THE INVENTION

The present invention provides a connection between a valve, such as a ball valve, and a pipe fitting of differing diameter. The connection comprises an adapter, one end of which is threadably engaged with an inlet or outlet of the ball valve body. The other end of the adapter is inserted and secured into a port or entry passageway of the pipe fitting. The assembly of the invention advantageously provides a strong compact connection between the pipe fitting and the ball valve.

In one embodiment, the present invention provides a ball valve connector assembly. The ball valve includes a body with a passageway having a first diameter and two ends. The ends of the body are circumvolved by male threads. The connector assembly includes a cylindrical adapter having a first end and a second end. The first end has female threads to engage the male threads on one end of the body to form a leak-resistant seal between the valve body and the adapter. The adapter has a passageway, which may be tapered, for allowing fluid communication between the valve body and the adapter. The assembly of the present invention further includes a pipe fitting having an entry passageway which has a second diameter. The second end of the adapter is inserted into and secured in the entry passageway of the pipe fitting. The diameter of the outer circumference of the adapter is substantially the same as the diameter of the entry passageway of the pipe fitting. The adapter can be connected within the entry passageway of the pipe fitting as is known in the art.

The present invention also provides a method of fitting a ball valve to a pipe fitting that recesses one end of the ball valve into the pipe fitting to minimize the distance between the ball valve and the pipe fitting. The method of the invention comprises the steps of providing a ball valve having a body with a passageway having a first diameter and two ends circumvolved by male threads; providing an adapter having a passageway with an inner diameter substantially the same as the inner diameter of the passageway of the body; threadably engaging one end of the adapter with one end of the ball valve; and inserting and securing the other end of the adapter into an entry passageway of a pipe fitting to form a leak resistant seal between the adapter and the pipe fitting, the entry passageway having a second inner diameter which is substantially the same as the diameter of the outer circumference of the adapter.

In another aspect of the invention, an adapter is configured to interconnect a ball valve or other valve with a pipe fitting, wherein the valve has an end with a diameter greater than or equal to the pipe fitting. The adapter has a first end for receiving the ball valve and a second end for insertion into the pipe fitting. Alternatively, the second end of the adapter could fit over the pipe fitting, e.g., the second end could be configured in the general form of a socket for fitting over a spigot, pipe stub, etc. The adapter could have two outside diameters: a first diameter at the first end and a second diameter at the second end, the first and second diameters at the first and second ends bridged by a shoulder.

### BRIEF DESCRIPTION OF THE FIGURES

Other important objects and features of the invention will be apparent from the following Detailed Description of the Invention taken in connection with the accompanying drawings in which:

FIG. 1 shows a cross-sectional side view of an assembled standard ball valve connection assembly, as is known in the art.

FIG. 2 shows a side exploded view of the components of the ball valve connection assembly of the present invention.

FIG. 3 shows a cross-sectional side view of an assembled ball valve connection assembly of the present invention.

FIG. 4 shows an exploded perspective view of another embodiment of valve connection assembly of the present invention.

FIG. 5 shows a perspective view of the assembly shown in FIG. 4 in an assembled configuration.

### DETAILED DESCRIPTION OF THE INVENTION

The valve connection assembly of the present invention is suitable for all applications of standard valves, particularly ball valves. The assembly of the present invention provides a more compact and sturdy connection than that provided by standard pipes and reducers typically used to connect conduits of varying diameters to valves. The assembly of the invention is applicable to connecting any type of conduit or pipe fitting, including tee, “Y,” elbow, and the like, to a valve such as a ball valve. The present invention is illustrated herein using a tee pipe fitting and ball valve, but may be applied to other valves and pipe fittings.

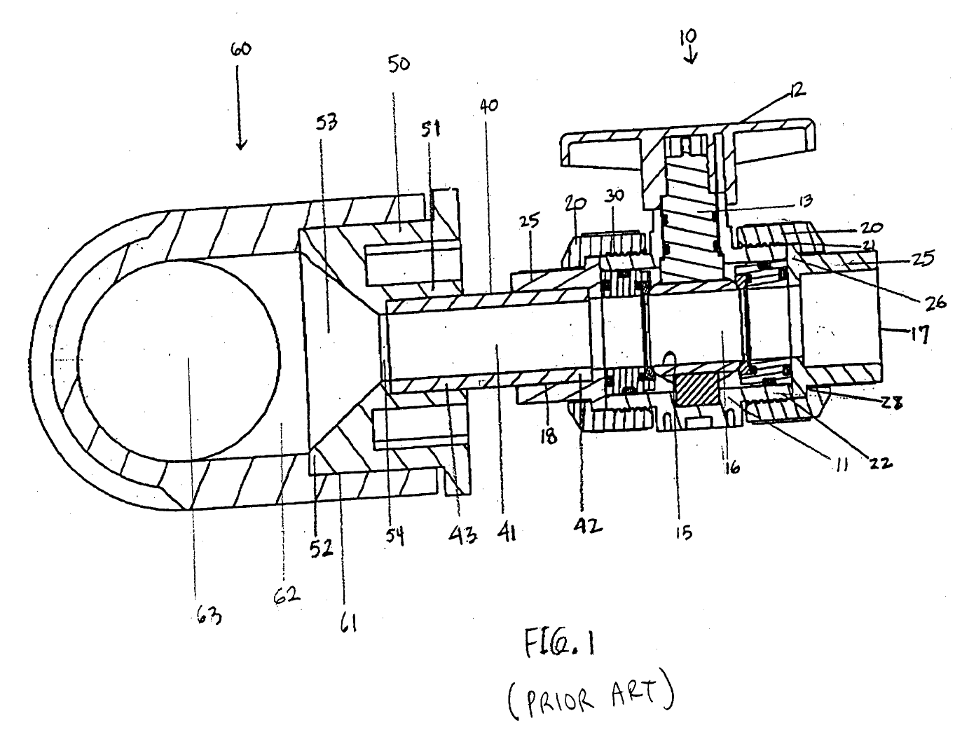

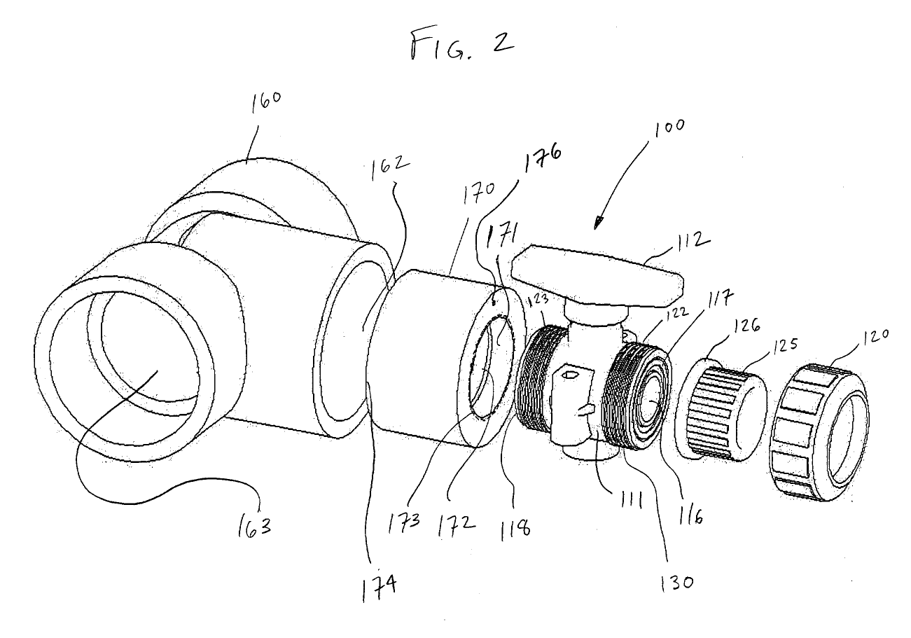

For purposes of illustration only, and not to be taken as limiting the claimed invention, FIG. 1 shows a tee connected to a ball valve as is known, while FIGS. 2-5 show the present invention. Prior to the present invention, standard ball valves were connected to tee pipe fittings in the configuration shown in FIG. 1. Ball valve 10 includes actuator handle 12 positioned on a stem 13, which passes through valve body 11 and attaches to ball 15. Fluid flows between outlet 17 and inlet 18 via passageway 16 running generally longitudinally through the center of valve body 11 when the actuator handle is turned to open the valve. It should be noted that the flow of fluid may be in either direction through the assembly, thus the terms “inlet” and “outlet” may be interchanged, and the various connections described herein may be attached to either the “inlet” or “outlet” of the body. However, for purposes of illustration of the devices shown in FIGS. 1-3, the designations are “outlet 17, 117, and inlet 18, 118”. Shoulder 26 of end connector 25 is positioned against outlet end 22 of valve body 11. End connector 25 is inserted through union nut 20. Male threads 30 on outlet end 22 of valve body 11 are threadably engaged to female threads 21 of union nut 20. Lip 28 of union nut 20 securely holds shoulder 26 of end connector 25 against outlet end 22 of valve body 11 to form a leak-resistant seal.

A length of pipe 40 is inserted between ball valve 10 and a tee pipe fitting 60, because tee pipe fitting 60 has passageway 62 of larger diameter than the diameter of passageway 16 of ball valve 10. One end 42 of pipe 40 is inserted into end connector 25. An opposite end 43 of the pipe 40 is inserted into a reducer 50. Pipe 40 has a passageway 41 of generally the same diameter as passageway 16 of ball valve 10. The reducer 50 is inserted into entry passageway 62 and is secured to inner wall 61 of tee pipe fitting 60 by bonding. The diameter of passageway 41 of pipe 40 also has generally the same diameter as passageway 54 of a first end 51 of reducer 50. Second end 52 of reducer 50 has a passageway 53 which increases in diameter from its connection with passageway 54 to a diameter generally the same as that of passageway 62 of tee 60. Main passageway 63 of the tee fitting 60 runs generally perpendicular to the entry passageway 62.

As discussed above, the disadvantage of this assembly is the structural weakness of pipe 40. Due to its overall length, and because it is substantially smaller in diameter than the rest of the assembly, this portion of the assembly is rendered the weakest and most susceptible to physical stress and damage. Further, the added length of the pipe expands the overall length of the entire connection assembly, thus increasing the moment arm and rendering the connection vulnerable to breakage if the ball valve is hit or bumped.

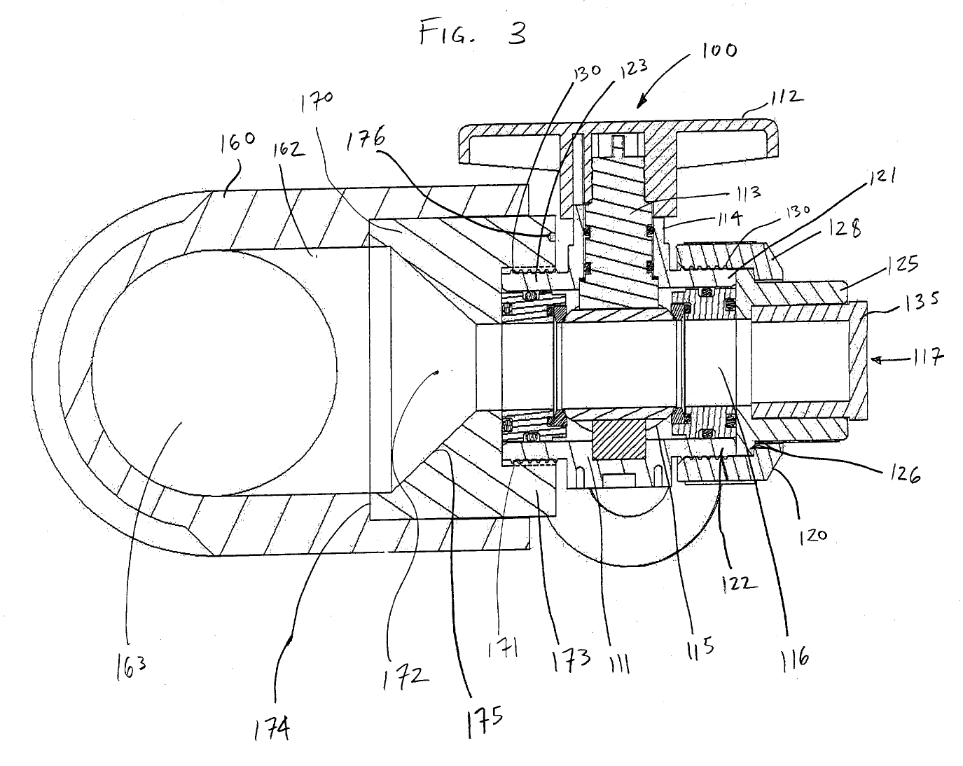

The present invention provides a more compact and sturdy assembly for connecting a valve and a pipe fitting. The invention uses a ball valve with one union nut 20 and one end connector 25, and an adapter. FIG. 2 shows an exploded side perspective view of the components of the present invention, which include a tee pipe fitting for illustration purposes. FIGS. 2 and 3 show ball valve 100 that includes actuator handle 112 positioned on stem 113, which passes through valve body 111 and is attached to ball 115. Fluid flows from inlet 118 to outlet 117 through passageway 116, running generally longitudinally through the center of valve body 111 when the actuator handle is turned to open the valve. Shoulder 126 of end connector 125 is positioned against outlet end 122 of valve body 111. End connector 125 is inserted through union nut 120. Male threads 130 on outlet end 122 of valve body 111 are threadably engaged by female threads 121 of union nut 120. Lip 128 of union nut 120 securely holds shoulder 126 of end connector 125 against outlet end 122 of valve body 111 to form a leak-resistant seal. A plug 135 may be inserted into end connector 125 to stop the flow of fluid through outlet 117, if desired, prior to connection of the outlet end 122 to a pipe system. The passageway 116 of valve body 111, the passageway 172 of adapter 170, and entry passageway 162 of tee pipe fitting 160 are generally aligned on a longitudinal axis. Main passageway 163 of tee pipe fitting 160 runs generally perpendicular to entry passageway 162.

An alignment marker 176 can optionally be provided on the adapter 170 to allow the valve 100 to be aligned with relation to the adapter 170. The marker 176 indicates the final location of the handle 112 of the valve 100 when the valve 100 is threaded into the adapter 170. A user can orient the alignment marker 176 relative to the geometry of the pipe fitting 160 upon installation of adapter 170, thus pre-selecting the final position of handle 112. When the valve 100 is fully threaded into the adapter 170, the handle 112 is oriented proximal to the alignment marker 176. The marker 176 can be in the form of a dimple on the edge of end 173 of the adapter 170.

In order to make a connection to tee 160 having entry passageway 162 of a larger diameter than the diameter of passageway 116 of ball valve 100, adapter 170 includes internal threads 171 and is threadably engaged to valve body 111. Adapter 170 has a passageway 172 for allowing fluid communication between the pipe fitting 160 and the valve 100. In a preferred embodiment of the present invention, the passageway 172 has a taper 175, wherein the end of the passageway 172 near the inlet end 123 of the valve 100 has a diameter equal to the diameter of the internal passageway 116, and the opposite end of the passageway 172 has a diameter equal to the entry passageway 162 of the pipe fitting 160. Of course, any desired shape of the passageway 172 is considered within the scope of the present invention.

Female threads 171 on end 173 of adapter 170 engage male threads 130 on inlet end 123 of body 111, thus making a sealed fluid connection between passageway 116 of ball valve 100 and passageway 172 of adapter 170. Second end 174 of adapter 170 is inserted into entry passageway 162 of tee pipe fitting 160 and is secured therein by bonding as is known in the art. Further, the second end 174 of the adapter 170 could be joined to the pipe fitting 160 by butt fusion or socket fusion. Additionally, the adapter 170 can be manufactured of any suitable material, such as PVC.

FIG. 3 is a cross-sectional view of the ball valve interconnected with the tee pipe fitting. Ball valve 100 is threadably connected to adapter 170 which, in turn, is inserted into and secured by tee pipe fitting 160. First end 173 of adapter 170 is sized to be threadably connected to inlet end 123 of body 111 of ball valve 100 to form a leak-resistant seal, and to have substantially the same-diameter as body 111 of ball valve 100. Second end 174 of adapter 170 is sized to be inserted into and secured within entry passageway 162 of tee 160, to form a leak-resistant seal.

With the present invention, one end of the ball valve is essentially recessed into the pipe fitting or mounted closely to the pipe fitting using an adapter. Thus, compact connections to conduits of varying sizes may conveniently be made using fewer components than used in standard ball valve connection assemblies.

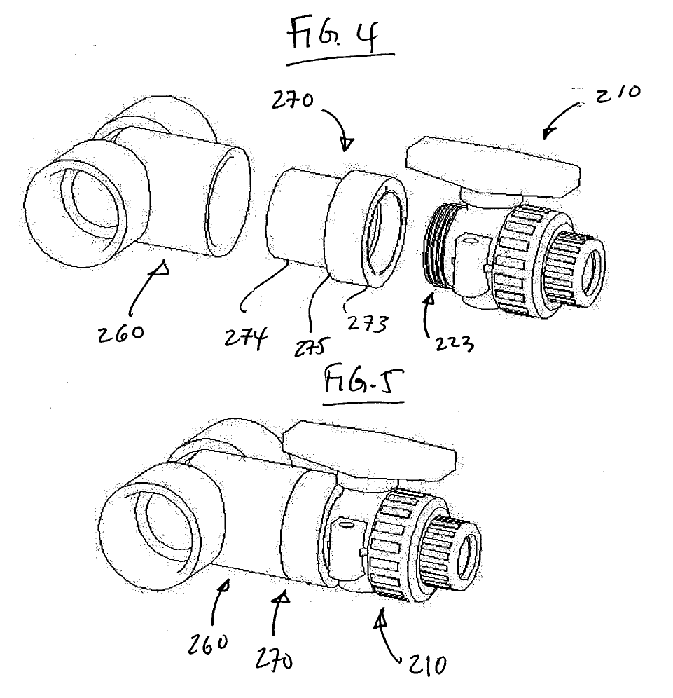

FIG. 4 shows another embodiment of the adapter of the present invention for connecting a valve and a pipe fitting where the valve has an outside diameter that is near or greater than the inner diameter of the pipe fitting. Ball valve 210 includes an inlet end 223 which is connected to adapter 270. Inlet end 223 is received by first end 273 of adapter 270. The connection between the inlet end 223 and the first end 273 of adapter 270 can be made in any manner known in the art. Second end 274 of adapter 270 is sized to be received by and interconnected with pipe fitting 260 in any manner known in the art. A shoulder or step 275 can be used to transition from a larger first outside diameter at first end 273 of adapter 270 to a second smaller outside diameter at second end 274.

FIG. 5 shows the components of FIG. 4 assembled. FIG. 5 shows the adapter 270 connecting a valve 210 with a pipe fitting 260. This embodiment of the adapter allows for the valve to be positioned close to the pipe fitting. As can be readily appreciated, the adapter of the present invention provides a compact and strong connection between a valve and a pipe fitting, and reduces the possibility of breakage of the connection.

Having thus described the invention in detail, it is to be understood that the foregoing description is not intended to limit the spirit and scope thereof. What is desired to be protected by Letters Patent is set forth in the appended claims.

What is claimed is:

1. A valve connector assembly comprising:
a valve having a body with a passageway, the ends of the body circumvolved by threads, and the passageway having a first diameter;
a cylindrical adapter having a first end and a second end, the first end having threads to engage the threads on one end of the body of the valve; and
a pipe fitting having an entry passageway with a second diameter;
wherein the second end of the adapter is inserted and secured in the entry passageway of the pipe fitting to connect the ball valve and the pipe fitting.

2. The connector of claim 1, wherein the valve comprises a ball valve.

3. A valve connector assembly comprising:
a valve having a body;
an adapter having a first end and a second end, the first end sized to receive one end of the body of the valve; and
a pipe fitting having an entry passageway sized to receive a second end of the adapter;
wherein the valve body is inserted into and secured within the adapter, and the adapter is inserted into and secured within the pipe fitting to connect the valve and the pipe fitting.

4. The valve connector assembly of claim 3, wherein the valve comprises a ball valve.

5. The valve connector assembly of claim 4, wherein the pipe fitting comprises a tee.

6. The valve connector assembly of claim 4, wherein the pipe fitting comprises a Y.

7. The valve connector assembly of claim 4, wherein the pipe fitting comprises an elbow.

8. The valve connector assembly of claim 3, wherein the adapter is secured in the pipe fitting by bonding.

9. The valve connector assembly of claim 3, wherein the adapter and valve have passageways therethrough having the same diameter.

10. The valve connector assembly of claim 3, wherein the first end of the adapter has a first outside diameter and the second end has a second outside diameter, the first outside diameter being greater than the second.

11. The valve connector assembly of claim 10, further comprising a step between the first and second outside diameters.

12. The valve connector assembly of claim 3, wherein the adapter further comprises a tapered passageway for providing fluid communication between the valve and the pipe fitting.

13. A valve connector assembly comprising:
a valve having a body;
an adapter having a unitary, one-piece construction and including a first end and a second end, the first end sized to receive one end of the body of the valve; and
a pipe fitting connected with the second end of the adapter;
wherein the valve body is connected to the adapter, and the adapter is connected to the pipe fitting to connect the valve and the pipe fitting.

14. The valve connector assembly of claim 13, wherein the valve comprises a ball valve.

15. The valve connector assembly of claim 14, wherein the pipe fitting comprises a tee.

16. The valve connector assembly of claim 14, wherein the pipe fitting comprises a Y.

17. The valve connector assembly of claim 14, wherein the pipe fitting comprises an elbow.

18. The valve connector assembly of claim 13, wherein the adapter is secured to the pipe fitting by bonding.

19. The valve connector assembly of claim 13, wherein the adapter and valve have passageways therethrough having the same diameter.

20. The apparatus of claim 13, wherein the first end of the adapter has a first outside diameter and the second end has a second outside diameter, the first outside diameter being greater than the second.

21. The apparatus of claim 20, further comprising a step between the first and second outside diameters.

22. The apparatus of claim 13, wherein the adapter further comprises a tapered passageway for providing fluid communication between the valve and the pipe fitting.

23. The valve connector assembly of claim 13, wherein the adapter is connected to the pipe fitting by insertion into the pipe fitting.

24. The valve connector assembly of claim 13, wherein the adapter extends about the pipe fitting.

25. A valve connector assembly comprising:
a valve having a body with a first end;
an adapter having first and second ends, the first end receiving the first end of the valve body within the adapter; and
a pipe fitting having an entry for receiving the adapter such that the adapter and the first end of the valve body is positioned within the pipe fitting.

26. The valve connector assembly of claim 25, wherein an end of the valve body is circumvolved by male threads and the adapter includes female threads to engage the male threads on the valve body.

27. The valve connector assembly of claim 26, wherein the valve is a ball valve.

28. The valve connector assembly of claim 26, wherein the pipe fitting is a tee.

29. The valve connector assembly of claim 26, wherein the pipe fitting is a Y.

30. The valve connector assembly of claim 26, wherein the pipe fitting is an elbow.

31. The valve connector assembly of claim 25, wherein the adapter further comprises a tapered passageway for providing fluid communication between the valve and the pipe fitting.

32. A valve connector assembly comprising:
a valve having a first end;
an adapter having a unitary, one-piece construction with first and second ends;
means for connecting a first end of the adapter about a first end of the valve; and
means for connecting the second end of the adapter to a pipe fitting.

33. The valve connector assembly of claim 32, wherein the first end of the adapter has a first outside diameter and the second end has a second outside diameter, the first outside diameter being greater than the second.

34. The valve connector assembly of claim 32, wherein the valve comprises a ball valve.

35. The valve connector assembly of claim 34, wherein the pipe fitting comprises a tee.

36. The valve connector assembly of claim 34, wherein the pipe fitting comprises a Y.

37. The valve connector assembly of claim 34, wherein the pipe fitting comprises an elbow.

38. The valve connector assembly of claim 32, further comprising a shoulder between the first and second outside diameters.

39. The valve connector assembly of claim 32, wherein the adapter further comprises a tapered passageway for providing fluid communication between the valve and the pipe fitting.

40. The valve connector assembly of claim 32, wherein the adapter further comprises an alignment marker for aligning the valve with relation to the adapter.

41. A method of connecting a valve to a pipe fitting comprising:
providing a valve having a body with two ends;
providing an adapter having an inner diameter sized to receive one end of the valve body;
inserting and securing one end of the valve body within the adapter; and
inserting and securing the adapter into a pipe fitting.

42. The method of claim 41, wherein the valve comprises a ball valve.

43. The method of claim 42, wherein the pipe fitting is a tee.

44. The method of claim 42, wherein the pipe fitting is a Y.

45. The method of claim 42, wherein the pipe fitting is an elbow.

46. The method of claim 41, wherein the step of inserting and securing one end of the valve body within the adapter comprises threadably engaging male threads on the valve body with female threads within the adapter.

47. The method of claim 41, wherein the step of inserting and securing the adapter into a pipe fitting comprises bonding the adapter and the pipe fitting.

48. The method of claim 41, wherein the adapter has a first outside diameter at a first end and a second outside diameter at a second end, the first outside diameter being greater than the second outside diameter, the first and second outside diameters having a step therebetween, and the step of inserting the adapter into the pipe fitting comprises inserting the second end of the adapter into the pipe fitting.

49. A method of connecting a valve to a pipe fitting comprising:
providing a valve having a body with a passageway having a first inner diameter and two ends circumvolved with threads;
providing an adapter having a passageway with an inner diameter substantially the same as the first inner diameter of the body, and an outer diameter;
threadably engaging the adapter with one end of the valve; and
inserting and securing the adapter into an entry passageway of a pipe fitting to form a leak resistant seal between the adapter and the pipe fitting, the entry passageway having a second inner diameter which is substantially the same as the outer diameter of the adapter.
